(19) United States
(12) Patent Application Publication
(10) Pub. No.: US 2006/0233618 A1
(43) Pub. Date: Oct. 19, 2006

(54) Power tool having power-take-off driven chuck with dust protection features

(76) Inventors: Daniel Puzio, Baltimore, MD (US); Brian G. Hendricks, Abington, MD (US)

Correspondence Address: HARNESS, DICKEY & PIERCE, P.L.C., P.O. BOX 828, BLOOMFIELD HILLS, MI, 48303, US

(21) Appl. No.: 11/389,625

(22) Filed: Mar. 24, 2006

Related U.S. Application Data
(60) Provisional application No. 60/672,583, filed on Apr. 19, 2005.

(51) Int. Cl. B23B 45/00

(52) U.S. Cl. 408/67

(57) ABSTRACT

A chuck that includes jaws, a first housing, which has a jaw cavity into which the jaws are received, a shaft and a second housing. The shaft and jaws are coupled so that relative rotation between the shaft and the first housing translates the jaws so that they converge toward or diverge from the shaft's rotational axis. The second housing includes a chuck cavity into which the first housing is received, and an opening that extends through the second housing and intersects the chuck cavity. The chuck is resistant to infiltration of debris and/or has an easily accessed interior that can be cleaned. In one example, the chuck includes a means for inhibiting infiltration of debris through the opening into the chuck cavity. In another example, the second housing has two portions that may be uncoupled from one another to permit access to an interior portion of the chuck.

### CROSS-REFERENCE TO RELATED APPLICATIONS

This application claims the benefit of U.S. Provisional Patent Application Ser. No. 60/672,583 filed Apr. 19, 2005 entitled “PTO—Dust Protection Features”, the disclosure of which is hereby incorporated by reference as if fully set forth herein in its entirety.

### INTRODUCTION

The present disclosure generally relates to chucks and chuck arrangements for power tools and more particularly to a power tool having a power-take-off driven chuck with dust protection features.

Power-take-off (PTO) driven chucks (i.e., chucks whose jaws can be driven open or closed via a PTO mechanism that can be selectively driven by an electrically or fluid driven (e.g., pneumatic) driven motor) are described in more detail in corresponding U.S. Provisional Patent Application Ser. No. 60/672,503 filed Apr. 19, 2005 entitled “TOOL CHUCK WITH POWER TAKE OFF AND DEAD SPINDLE FEATURE”, the disclosure of which is hereby incorporated by reference as if set forth herein in its entirety.

In the course of our work on PTO-driven chucks, we have found that the general configuration of PTO-driven chucks lends itself to various improvements that have not heretofore been incorporated into other chucks. One such line of improvement relates to the infiltration of dust into the interior of the chuck and more specifically, methods and devices for preventing dust and debris from entering into the interior of the chuck and/or for removing dust and debris from the interior of the chuck.

Often times, power tools with a chuck, such as a drill, drill-driver or hammer-drill-driver, for example, are used “overhead” wherein dust and debris can fall directly into the interior of the chuck (e.g., between the jaws or between the jaws and the shaft or spindle). The users of such tools may occasionally attempt to clean the interior of the chuck through the use of fluids such as compressed air or WD-40®. Unfortunately, such methods for the removal of dust and debris from the interior of the chuck are typically undertaken when the operator of the tool notices seizing or binding when the chuck jaws are opened or closed and at such points, the chuck has experienced accelerated wear. Accordingly, there remains a need in the art for devices and methods which could reduce or eliminate the infiltration of dirt and debris into the interior of a chuck, as well as chuck configurations and methods that permit the interior of a PTO-driven chuck to be more easily cleaned.

### SUMMARY

In one form, the present teachings provide a chuck that includes a first housing, a plurality of jaws, a shaft and a second housing. The first housing has a jaw cavity into which the jaws are received. The shaft is coupled to the jaws such that relative rotation between the shaft and the first housing translates the jaws so that they converge toward or diverge from a rotational axis of the shaft. The second housing is configured to be non-rotatably coupled to a tool housing of a drill/driver. The second housing includes a chuck cavity into which the first housing is received, and an opening that extends through the second housing and intersecting the chuck cavity. The chuck also includes a means for inhibiting infiltration of debris through the opening into the chuck cavity.

In another form, the present teachings provide a chuck that includes a first housing, a plurality of jaws, a shaft and a second housing. The first housing has a jaw cavity into which the jaws are received. The shaft is coupled to the jaws such that relative rotation between the shaft and the first housing translates the jaws so that they converge toward or diverge from a rotational axis of the shaft. The second housing having a first housing portion, which is configured to be coupled to a tool housing of a drill/driver, and a second housing portion that is removably coupled to the first housing portion.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic illustration of an exemplary power tool having a PTO-driven tool chuck constructed in accordance with the teachings of the present disclosure;

FIG. 2 is an exploded perspective view of a portion of the power tool of FIG. 1, illustrating the PTO mechanism in greater detail;

FIG. 3 is a sectional perspective view of a portion of the tool of FIG. 1 illustrating the chuck as mounted on the PTO mechanism;

FIG. 4 is a sectional view of a portion of the tool of FIG. 1 illustrating a mode ring and a shift collar for changing an operational mode of the tool;

FIG. 5 is an enlarged portion of FIG. 4 illustrating the PTO-driven tool chuck in more detail;

FIG. 6 is a sectional view of a portion of another power tool having a second PTO-driven chuck constructed in accordance with the teachings of the present disclosure;

FIG. 7 is a sectional view of a portion of another power tool having a third PTO-driven chuck constructed in accordance with the teachings of the present disclosure;

FIGS. 8 and 9 are a sectional views of power tools that are similar to that of FIG. 7 but which illustrate different means for coupling the first and second portions of the driver housing to one another;

FIG. 10 is a sectional view of another power tool having a fourth PTO-driven chuck constructed in accordance with the teachings of the present disclosure;

FIG. 11 is a sectional view of a power tool having a fifth PTO-driven chuck constructed in accordance with the teachings of the present disclosure; and

FIG. 12 is a sectional view of yet another power tool having a sixth PTO-driven chuck constructed in accordance with the teachings of the present disclosure.

### DETAILED DESCRIPTION OF THE VARIOUS EMBODIMENTS

With reference to FIG. 1, an exemplary power tool T, such as a drill/driver or hammer drill/driver, is schematically illustrated. The power tool T can include a PTO-driven tool chuck 50 that is constructed in accordance with the teachings of the present disclosure. It will be appreciated, however, that the tool chuck 50 may be suitably implemented on a variety of power drivers (other than drills and hammer drills) for holding a variety of tools (other than drill bits).

The tool chuck 50 may be connected to the transmission 70 of a power driver via a power take off (“PTO”) mechanism 10. The transmission 70 may be coupled to an electric motor 90. The transmission 70 may use gearing to effect a change in the ratio between an input rpm (from the electric motor 90) and an output rpm (delivered to the tool chuck 50).

In this example embodiment, the transmission 70 may include three planetary reduction systems. It will be appreciated, however, that the invention is not limited in this regard. For example, more or less than three planetary reduction systems may be implemented. Further, transmissions other than planetary reduction system transmissions (e.g., conventional parallel axis transmissions) may be suitably implemented. Planetary reduction transmissions are well known in this art, and therefore a detailed discussion of the same is omitted. The PTO mechanism 10 may be provided at the output of the transmission 70.

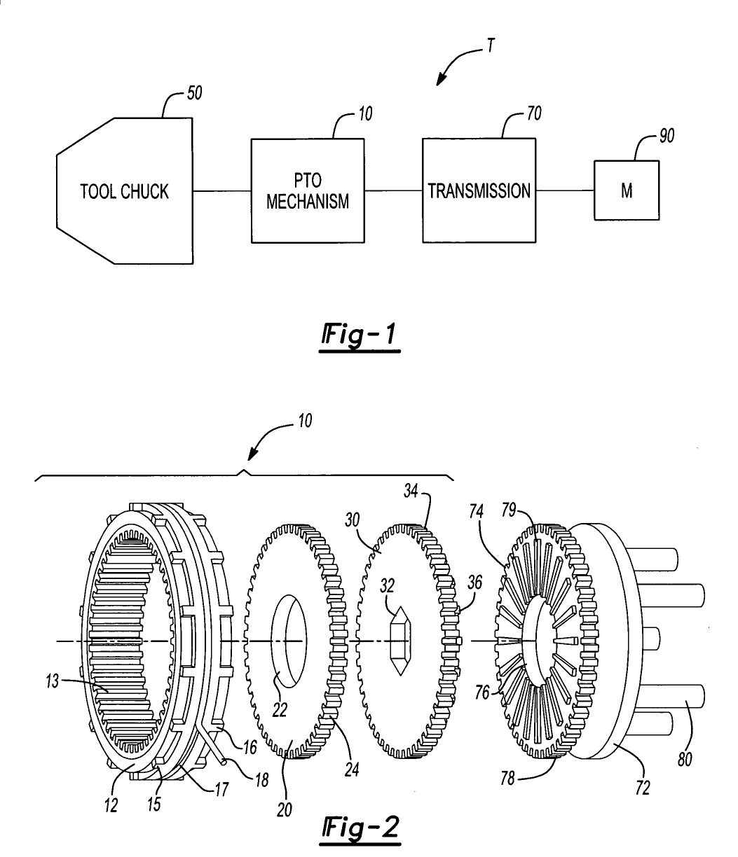

FIG. 2 is an exploded perspective view of the PTO mechanism 10. In this example embodiment, the PTO mechanism 10 may include a shift ring 12, an output coupling 20 and a PTO drive disk 30.

The shift ring 12 may have a radial inward facing surface provided with splines 13 (for selectively engaging with the output coupling 20, the PTO drive disk 30 and a disk 74 of the third stage carrier 72). The shift ring 12 may have a radial outward facing surface provided with forwardly extended splines 15 and rearwardly extended splines 16 (for selective engaging with a housing of the driver, not shown) and a continuous circumferential groove 17 (for accommodating a wire 18).

The wire 18, which may be slidable through the circumferential groove 17, may have free ends that extend in a radial direction and out of the circumferential groove 17. The fee ends of the wire 18 (serving as cam followers) may be received in a slot of a shift collar rotatably mounted on the driver housing. Upon rotating the shift collar, the slot may influence the cam followers (and thus the shift ring 12) to the desired axial positions, as will be discussed in more detail below.

The output coupling 20 may include a central aperture 22 having a shape that corresponds to the shape of an input shaft 60, discussed in more detail below. The output coupling 20 may have a radial outward facing surface provided with splines 24 that selectively cooperate with the radial inward facing splines 13 of the shift ring 12.

The PTO drive disk 30 may include a central aperture 32 having a shape that corresponds to the shape of a PTO actuator shaft, discussed in more detail below. The PTO drive disk 30 may have a radial outward facing surface provided with splines 34 that selectively cooperate with the radial inward facing splines 13 of the shift ring 12. The PTO drive disk 30 may have an axial rearward facing surface provided with clutch features 36. In this example embodiment, the clutch features 36 may be in the form of elongated projections that extend in a radial fashion across the axial rearward facing surface of the PTO drive disk 30.

The disk 74 of the third stage carrier 72 may include a central aperture 76 that extends axially through the third stage carrier 72. The disk 74 may have a radial outward facing surface provided with splines 78 that selectively cooperate with the radial inward facing splines 13 of the shift ring 12. The disk 74 may also include an axial forward facing surface provided with clutch features 79. In this example embodiment, the clutch features 79 may be in the form of elongated projections that extend in a radial fashion across the axial forward facing surface of the disk 74. The clutch features 79 of the disk 74 may cooperate with the clutch features 36 of the PTO drive disk 30. As is well known in this art, the third stage carrier 72 may include shafts 80 that rotatably support planetary gears (not shown).

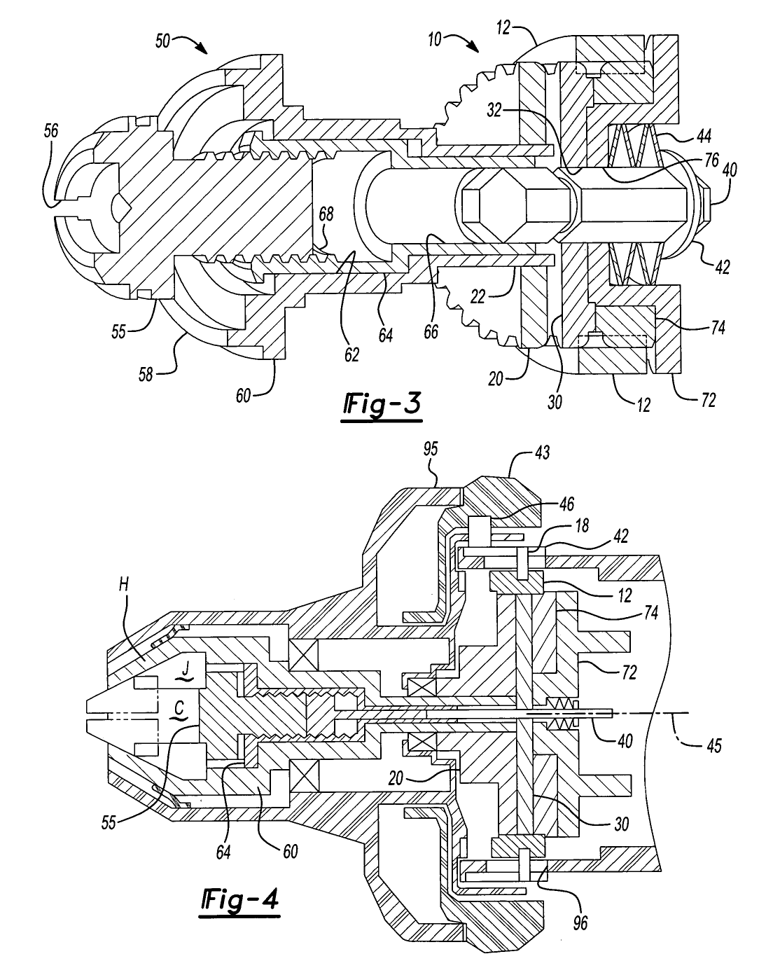

FIG. 3 is a sectional perspective view of the PTO mechanism 10 assembled together with the tool chuck 50. Here, the shift ring 12 is shown in phantom for clarity.

The tool chuck 50 may include an input shaft 60. A forward end of the input shaft 60 may include a housing H (FIG. 4) that defines a jaw cavity C (FIG. 4) having passageways through which chuck jaws J (FIG. 4) are respectively slidable. The passageways of the nose portion may rotationally fix the input shaft 60 to the chuck jaws. The input shaft 60 may have a rear end that extends through the central aperture 22 of the output coupling 20. The rear end of the input shaft 60 may have a radial outward facing surface provided with features that cooperate with corresponding features provided on the radial inward facing surface defining the central aperture 22 so that the input shaft 60 may be rotationally locked to the output coupling 20. Such features are well known in this art. By way of example only, the input shaft 60 may be provided with flats against which flats of the central aperture 22 may abut to rotationally lock together the input shaft 60 and the output coupling 20. The input shaft 60 may include a through bore 62. The through bore 62 may rotatably support a chuck actuating shaft 64.

The chuck actuating shaft 64 may include a through bore 66. The through bore 66 may have a rear end receiving a PTO actuator shaft 40. The rear end of the through bore 66 and the PTO actuator shaft 40 may have corresponding shapes to rotationally fix the chuck actuating shaft 64 to the PTO actuator shaft 40. The forward end of the through bore 66 may be provided with radial inward facing threads 68 that may interact with radial outward facing threads 58 of a chuck actuating screw 55. That is, the chuck actuating shaft 64 may be screw coupled to the chuck actuating screw 55.

The chuck actuating screw 55 may include radial passageways 56 through which the chuck jaws are respectively slidable. The radial passageways 56 may rotationally fix the chuck actuating screw 55 to the chuck jaws. The interaction between the threads 58 and 68 may cause the chuck actuating screw 55 to advance and retract in the axial direction relative to the input shaft 60. It will be appreciated that the chuck actuating screw 55 and input shaft 60 may be rotationally locked together via the chuck jaws.

The PTO actuator shaft 40 extends through the through bore 66 of the chuck actuating shaft 64, the central aperture 33 of the PTO drive disk 30 and the central aperture 76 of the disk 74. A keeper 42 (in the form of a snap ring, for example) may be mounted on the PTO actuator shaft 40. A spring 44 may be mounted on the PTO actuator shaft 40 and compressed between the third stage carrier 72 and the keeper 42. The PTO actuator shaft 40 may support another keeper (not shown for clarity) via a slot located axially forward of the PTO drive disk 30. As noted above, the PTO actuator shaft 40 may have a shape that corresponds to the shape of the central aperture 32 of the PTO drive disk 30. In this way, the PTO actuator shaft 40 may be rotationally fixed to the PTO drive disk 30.

As shown in FIG. 3, the output coupling 20, the PTO drive disk 30 and the disk 74 of the third stage carrier 72 may be assembled together in a coaxial fashion. Here, the clutch features 36 of the PTO drive disk 30 may face (and engage with) the clutch features 79 of the disk 74. Also, the shift ring 12 (shown in phantom) may be mounted for axial movement so that the radial inward facing splines 13 of the shift ring 12 may selectively engage with the radial outward facing splines 24 of the output coupling 20, the radial outward facing splines 34 of the PTO drive disk 30 and the radial outward facing splines 78 of the disk 74.

The tool chuck 50 may operate differently depending on the axial position of shift ring 12, which may assume three different operating positions inclusive of a MANUAL OVERRID MODE, a DRILL/DRIVE MODE and a CHUCK MODE.

FIG. 3 illustrates the shift ring 12 in the MANUAL OVERRIDE MODE, in which the shift ring 12 may be located at an axial rearward position. Here, the radial outward facing splines 16 of the shift ring 12 may engage with corresponding features provided on the driver housing (not shown). Thus, the shift ring 12 may be rotationally fixed (or grounded) to the driver housing. The radial inward facing splines 13 of the shift ring 12 may engage with the radial outward facing splines 34 of the PTO drive disk 30 and the radial outward facing splines 78 of the disk 74. Thus, the shift ring 12, the PTO drive disk 30 (and therefore the PTO actuator shaft 40) and the disk 74 (and therefore the third stage carrier 72) may be rotationally grounded to the driver housing. In this condition, the output coupling 20 and the input shaft 60 may remain rotatable relative to the driver housing.

A user may grasp and manually rotate the input shaft 60 (together with the chuck jaws and the chuck actuating screw 55) relative to the driver housing. The chuck actuating screw 55 may rotate relative to the chuck actuating shaft 64, which may be rotationally fixed to the PTO actuator shaft 40 (and therefore may be rotationally grounded to the driver housing). This relative rotation may cause the chuck actuating screw 55 to advance or retract in the axial direction (depending on the rotation direction of the input shaft 60) by virtue of the interaction between the radially inward facing threads 68 and the radially outward facing threads 58. The translational movement of the chuck actuating screw 55 may push or pull on the chuck jaws to open or close the same.

For example, during a closing operation, the chuck actuating screw 55 (together with the chuck jaws) may be advanced in the axial direction. During this time, the passageways of the nose portion of the input shaft 60 may influence the chuck jaws 2 in a radial inward direction through the radial passageways 56 of the chuck actuating screw 55. This pusher type jaw action is well known in the pertinent art.

The DRILL/DRIVE MODE may be achieved by sliding the shift ring 12 forward to an intermediate axial position. Here, the shift ring 12 may be disengaged from (and rotatable relative to) the driver housing. The radial inward facing splines 13 of the shift ring 12 may engage with the radial outward facing splines 24 of the output coupling 20, the radial outward facing splines 34 of the PTO drive disk 30 and the radial outward facing splines 78 of the disk 74. Thus, the shift ring 12, the output coupling 20 (and therefore the input shaft 60), the PTO drive disk 30 and the disk 74 (and therefore the third stage carrier 72) may be rotationally fixed together and rotatable as a unit. Since the PTO drive disk 30 (and therefore the PTO actuator shaft 40 and the chuck actuating shaft 64) and the output coupling 20 (and therefore the input shaft 60 and the chuck actuating screw 55) may be rotationally locked together, the tool chuck 50 may not loosen during operation. A user may then power up the driver to rotationally drive the tool chuck 50.

The CHUCK MODE may be achieved by sliding the shift ring 12 to a forward axial position. Here, the radial outward facing splines 15 of the shift ring 12 may engage with corresponding features provided on the driver housing. Thus, the shift ring 12 may be rotationally grounded to the driver housing. The radial inward facing splines 13 of the shift ring 12 may engage with the radial outward facing splines 24 of the output coupling 20. Thus, the shift ring 12 and the output coupling 20 (and therefore the input shaft 60 and the chuck actuating screw 55) may be rotationally grounded to the driver housing. Here, the PTO drive disk 30 (and therefore the PTO actuator shaft 40 and the chuck actuating shaft 64) and the disk 74 (and therefore the third stage carrier 72) may remain rotatable relative to the driver housing.

A user may then power up the driver to actuate the tool chuck 50. At this time, the third stage carrier 72 may rotationally drive the PTO drive disk 30 via the cooperating clutch features 79 and 36 respectively provided on the confronting surfaces of the disk 74 and the PTO drive disk 30. The PTO drive disk 30 may rotationally drive the PTO actuator shaft 40, which in turn may rotationally drive the chuck actuating shaft 64. The chuck actuating shaft 64 may rotate relative to the chuck actuating screw 55, which may remain rotationally grounded to the driver housing (via the chuck jaws, the input shaft 60, the output coupling 20 and the shift ring 12). This relative rotation may cause the chuck actuating screw 55 to advance or retract in the axial direction (depending on the rotation direction of the chuck actuating shaft 64) by virtue of the interaction between the radial inward facing threads 68 and the radial outward facing threads 58. The translational movement of the chuck actuating screw 55 may push or pull on the chuck jaws to open or close the same.

During chuck actuation, the input shaft 60, the chuck jaws and the chuck actuating screw 55 may remain rotationally grounded to the driver housing, while the chuck actuating screw 55 may move axially (via the rotational movements of the chuck actuating shaft 64) relative to the input shaft 60 to open and close the chuck jaws. This may be referred to as a dead spindle feature since the user may not be exposed to (or observe) any rotating parts.

Once the tool chuck 50 is tight (i.e., when the chuck jaws clamp the accessory) or fully opened, the cooperating clutch features 79 and 36 respectively provided on the confronting surfaces of the disk 74 and the PTO drive disk 30 may give way and slip relative to each other. At this time, the disk 74 (together with the third stage carrier 72) may move in an axial rearward direction against the influence of the spring 44. When the cooperating clutch features 79 and 36 slip, they may produce an audible indication that the chuck actuation process is complete.

The cooperating clutch features 79 and 36 may give way or slip at a predetermined torque threshold. The predetermined torque threshold may be suitably adjusted by selecting an appropriate spring 44 and/or by suitably designing the geometries of the cooperating clutch features 79 and 36. Further, the predetermined torque threshold for tightening the tool chuck 50 may be less than the predetermined torque threshold for loosening the tool chuck 50. This feature may be obtained by suitably designing the geometries of the cooperating clutch features 79 and 36. Numerous and varied clutch surface geometries are well known in this art, and therefore a detailed discussion of the same is omitted.

FIG. 4 shows an example, non-limiting embodiment of a mode ring 43 and a shift collar 42 that may be implemented to axially position the shift ring 12 depicted in FIGS. 2 and 3 to achieve the various operational modes. In FIG. 4, the portion of the drawing above the axis 45 depicts the DRILL/DRIVE MODE (where the shift ring 12 may be located at the intermediate axial position), and the portion of the drawing below the axis 45 depicts the CHUCK MODE (where the shift ring 12 may be located at the forward axial position).

The mode ring 43 and the shift collar 42 may be mounted for rotation on the driver housing 95. The mode ring 43 and the shift collar 42 may be rotationally fixed together via a radial extension 46. Thus, the mode ring 43 and the shift collar 42 may be rotatable together relative to the driver housing 95.

The shift collar 42 may include a slot that extends in a circumferential direction around the shift collar 42. In this example embodiment, the shift collar 42 may include two circumferential slots. The driver housing 95 may include longitudinal slots 96. The longitudinal slots 96 may extend across (and underneath) the circumferential slots of the shift collar 42. The ends of the wire 18 may extend in a radial outward direction from the shift ring 12, through the longitudinal slots 96 of the driver housing 95 and into the slots of the shift collar 42.

A user may rotate the mode ring 43 (and thus the shift collar 42) relative to the housing 95. At this time, the wire 18 may remain rotationally fixed to the housing 95 via the longitudinal slots 96. During this relative rotation, the ends of the wire 18 may slide through the circumferential slots of the shift collar 42. The shapes of the circumferential slots of the shift collar 42 may influence the wire 18 (and thus the shift ring 12) to the desired axial position. In this regard, the ends of the wire 18 may serve as cam followers and the corresponding circumferential slots may serve as cams. It will be appreciated that the circumferential slots of the shift collar 42 may extend in axial directions to thereby axially displace the shift ring 12.

In FIG. 5, the tool chuck 50 is shown to include a seal member 104 is received in the jaw cavity C between the driver housing 95 and the input shaft 60. In the particular example provided, the seal member 104 is a lip seal that is made of a resilient material, such as an elastomer. The seal member 104 can include a first portion 104a, which can be fixedly coupled to the driver housing 95, and a second portion 104b that can sealingly engage a circumferentially extending outer surface of the input shaft 60. As such, the seal member 104 can effectively inhibit dirt and debris from entering between the driver housing 95 and the input shaft 60.

Alternatively, the seal member 104 could be a labyrinth-type seal (not shown) having a first seal portion (not shown), which is non-rotatably and sealingly housed in the driver housing 95 and a second seal portion (not shown) that is coupled for rotation with the input shaft 60. Those of ordinary skill in the art will appreciate that the first and second seal portions can cooperate to form a labyrinth that would define a circuitous path that would effectively inhibit dirt and debris from entering between the driver housing 95 and the input shaft 60.

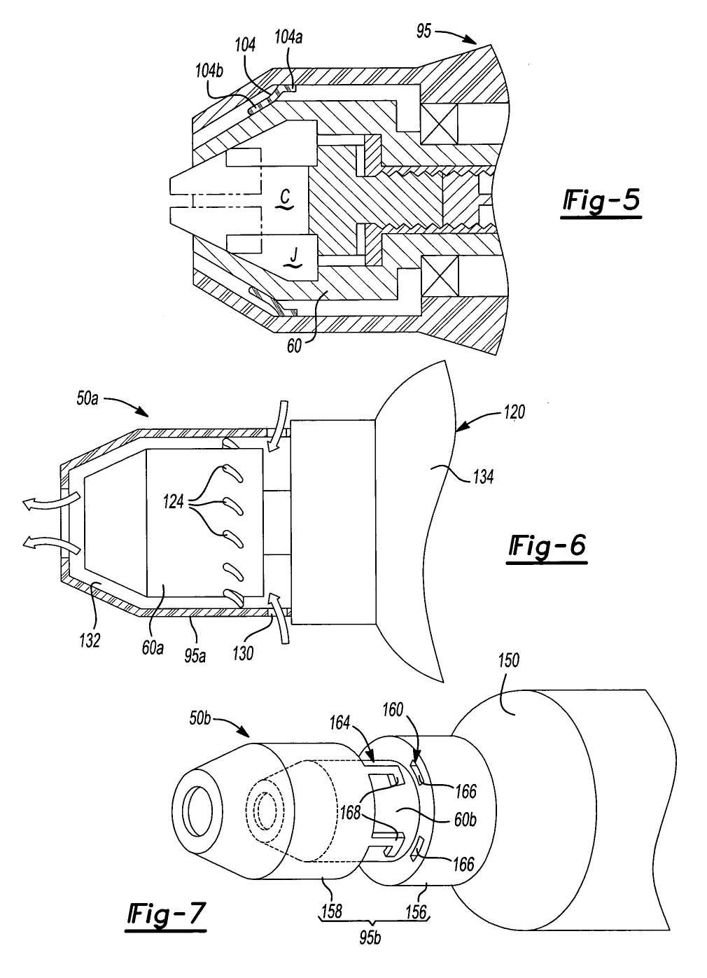

With reference to FIG. 6 of the drawings, a second exemplary power tool 120 is illustrated to include a PTO-driven chuck 50a constructed in accordance with the teachings of the present disclosure. The PTO-driven chuck 50a is generally similar to the tool chuck 50 described above and illustrated in FIGS. 1 through 5, except that the seal member 104 is omitted and a plurality of vanes or fan blades 124 can be coupled for rotation with the input shaft 60a and the driver housing 95a can be configured with one or more input apertures 130 and one or more output apertures 132. The input aperture or apertures 130 can be formed through any appropriate portion of the driver housing 95a and can provide direct access to the atmosphere (as shown) or may provide access to the atmosphere via a path through other portions of the power tool 120, such as the tool body 134. The output aperture or apertures 132 can be disposed proximate the distal end of the PTO-driven chuck 50a, such as at a (forward) point where the driver housing 95a terminates.

During the operation of the power tool 120, rotation of the input shaft 60a causes the fan blades 124 so that air is pushed forwardly and out of the interior of the PTO-driven chuck 50a through the output aperture or apertures 132. The air exiting through the output aperture or apertures 132 will tend to blow dust and debris away from the forward end of the PTO-driven chuck 50a and thus reduce the likelihood that dirt and debris will enter the interior of the PTO-driven chuck 50a. The air exiting through the output aperture or apertures 132 will also tend to reduce the air pressure in the interior of the PTO-driven chuck 50a rearwardly of the fan blades 124 so that atmospheric air pressure will tend to drive (fresh) air into through the input aperture or apertures 130.

It will be appreciated that the output aperture or apertures 132 need not be disposed between the input shaft 60a and the driver housing 95a, but rather could be formed by spaces between the input shaft 60a and the chuck jaws. In this embodiment, a plurality of air passages can be formed through the input shaft 60a into an interior area where the chuck jaws are disposed. It will also be appreciated that in this alternative embodiment a seal member, such as that which is described in conjunction with the above-described example of FIGS. 1-5 can be employed to form a seal between the input shaft 60a and the driver housing 95a.

It will also be appreciated that while the air flow has described as flowing outwardly from a forward end of the PTO-driven chuck 50a, those of ordinary skill in the art will appreciate that the fan blades 124 could be configured in the alternative to cause air to be drawn into the PTO-driven chuck 50a from its forward end.

With reference to FIG. 7 of the drawings, a third exemplary power tool 150 is illustrated to include a PTO-driven chuck 50b constructed in accordance with the teachings of the present disclosure. The PTO-driven chuck 50b is generally similar to the tool chuck 50 described above and illustrated in FIGS. 1 through 5 or to the tool chuck 50a described above and illustrated in FIG. 6, except that the driver housing 95b can have a first portion 156 and a second portion 158 that can be fixedly but removably coupled to the first portion 156. In the particular embodiment provided, the first portion can include a first locking feature 160, while the second portion 158 can be configured to shroud the forward portion of the input shaft 60b and can include a second locking feature 164 that permits the second portion 158 to be fixedly but removably engaged to the first portion 156. Construction in this manner renders the second portion 158 readily removable from the first portion 156 so that the maintenance may be more easily performed on the interior of the PTO-driven chuck 50b.

In the particular example provided, the first locking feature 160 includes a plurality of arcuate slots 166 that are spaced radially outwardly from the input shaft 60b, while the second locking feature 164 includes a plurality of bayonet locking features 168 that are configured to extend through corresponding ones of the arcuate slots 166 and fixedly but removably engage the first portion 156 of the driver housing 95b. Bayonet-type locking systems are well known in the art and as such, a detailed discussion of the bayonet locking features, their construction and operation, need not be provided herein.

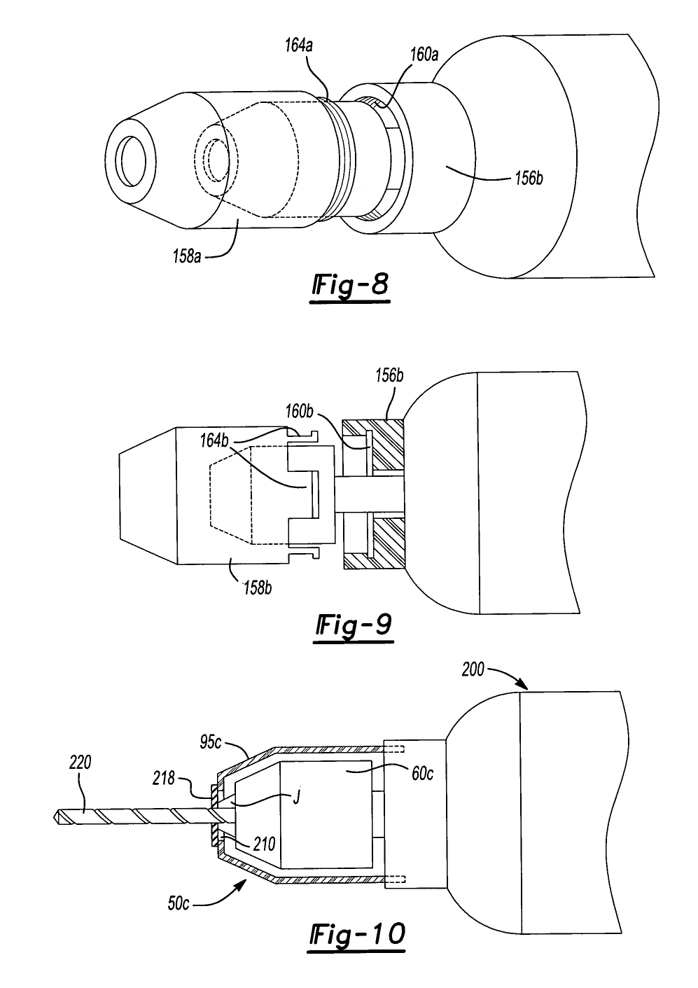

Alternatively, the first and second locking features may be constructed as is shown in FIG. 8 or 9. With reference to FIG. 8, the first locking feature 160a can be a female threadform, which can be formed on the first portion 156b, while the second locking feature 164a can be a male threadform that can be formed on the second portion 158b and can be threadably engage the female threadform of the first locking feature 160a.

With reference to FIG. 9, the first locking feature 160b can be an annular groove having a radially inwardly facing lip member (not specifically shown), while the second locking feature 164b can be a plurality of inwardly deflectable tabs, each of which having a radially outwardly extending member. When the second locking feature 164b is axially introduced into the annular groove, interaction between the radially inwardly facing lip member and the radially outwardly extending members can deflect the tabs inwardly, allowing the radially outwardly extending members to ride over the radially inwardly facing lip member and then lockingly engage the rear face of the radially inwardly facing lip member to thereby resist the withdrawal of the second portion 158b from the first portion 156b.

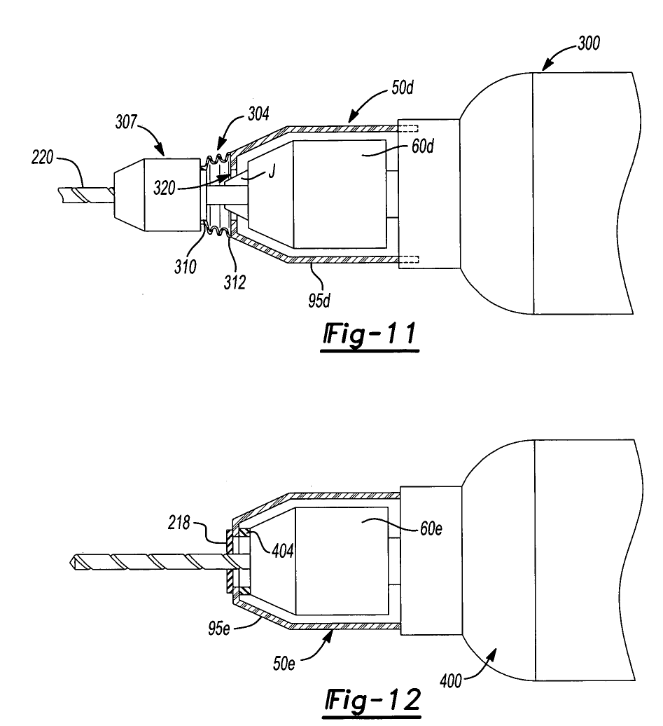

With reference to FIG. 10 of the drawings, a fourth exemplary power tool 200 is illustrated to include a PTO-driven chuck 50c constructed in accordance with the teachings of the present invention. The PTO-driven chuck 50c is generally similar to the tool chuck 50 described above and illustrated in FIGS. 1 through 5, except that the driver housing 95c extends forwardly around the input shaft 60c. An aperture 210 formed in the front of the driver housing 95c is sized in such a way as to be as small as possible while not interfering with the chuck jaws J when the PTO-driven chuck 50c is fully closed (i.e., when the chuck jaws J are moved to their forward-most position).

While the configuration of the driver housing 95c will greatly reduce the amount of dirt and debris that may come into contact with the PTO-driven chuck 50c, there remains a relatively small space between the chuck jaws J through which dirt and debris may enter the interior of the PTO-driven chuck 50c. Accordingly, a shroud member 218 may be employed to shroud the openings between the chuck jaws J. The shroud member 218 may be a disk-like structure of a resilient material, such as rubber, a closed-cell form or a “self-healing” foam, and may be installed over a tool bit 220, such as a drill bit, prior to operation of the power tool 200. The shroud member 218 may be removably coupled to the tool bit 220 or may be permanently coupled to the tool bit 220.

In situations where a pre-fabricated shroud member 218 is unavailable, one may form the shroud member 218 using a seal or washer (e.g., faucet washer, O-ring) or an adhesive tape that is wound over the shaft of the tool bit 220.

With reference to FIG. 11 of the drawings, an exemplary power tool 300 is illustrated to include a PTO-driven chuck 50d constructed in accordance with the teachings of the present invention. The PTO-driven chuck 50d is generally similar to the tool chuck 50 described above and illustrated in FIGS. 1 through 5, except that the seal member 104 (FIG. 5) can be omitted and a boot seal 304 can be coupled to the driver housing 95d. The boot seal 304 can engage a tool, such as a rapid-load chuck 307, that can be coupled for rotation with the input shaft 60d. The rapid-load chuck 307 may be any commercially available rapid-load chuck, such as an Apex QR-M-490-2 ¼″ hex drive quick-release chuck marketed by Cooper Power Tools of Lexington, S.C.

The boot seal 304 can have a first end 310, which can be non-rotatably coupled to the tool bit (e.g., the rapid-load chuck 307) and a second end 312 which can sealingly engage the driver housing 95d at a location that is radially outwardly of the aperture 320 in the driver housing 95d through which the chuck jaws J extend. Although the tool bit has been illustrated as being a rapid-load chuck, those of ordinary skill in the art will appreciate that the tool bit may be any type of tool bit that may be used in conjunction with a chuck and as such, the particular tool bit illustrated is not intended to limit the scope of the invention in any way.

Furthermore, although the boot seal 304 has been described as being non-rotatably coupled to the tool bit, those of ordinary skill in the art will appreciate that the invention, in its broadest aspects, may be constructed such that the second end 312 of the boot seal 304 is non-rotatably coupled to another portion of the PTO-driven chuck 50d, such as the driver housing 95d, and sealingly engaged to the tool bit in such a way as to permit relative rotation between the tool bit 220 and the boot seal 304.

With reference to FIG. 12 of the drawings, an exemplary power tool 400 is illustrated to include a PTO-driven chuck 50e constructed in accordance with the teachings of the present disclosure. The PTO-driven chuck 50e is generally similar to the tool chuck 50 described above and illustrated in FIGS. 1 through 5, except that a seal member 404 is disposed between the driver housing 95e and the input shaft 60e. In the particular example provided, the seal member 404 is a face seal that is made of a resilient material, such as an elastomer. The seal member 404 can be non-rotatably housed in the driver housing 95e and sealingly engaged to circumferentially extending surfaces formed on the driver housing 95e and the input shaft 60e to thereby inhibit dirt and debris from entering between the driver housing 95e and the input shaft 60e. A shroud member 218, such as that which is discussed above can be employed to further inhibit dirt and debris from entering the interior of the PTO-driven chuck 50e as described above.

While specific examples have been described in the specification and illustrated in the drawings, it will be understood by those of ordinary skill in the art that various changes may be made and equivalents may be substituted for elements thereof without departing from the scope of the present disclosure as defined in the claims. Furthermore, the mixing and matching of features, elements and/or functions between various examples is expressly contemplated herein so that one of ordinary skill in the art would appreciate from this disclosure that features, elements and/or functions of one example may be incorporated into another example as appropriate, unless described otherwise, above. Moreover, many modifications may be made to adapt a particular situation or material to the teachings of the present disclosure without departing from the essential scope thereof. Therefore, it is intended that the present disclosure not be limited to the particular examples illustrated by the drawings and described in the specification as the best mode presently contemplated for carrying out this invention, but that the scope of the present disclosure will include any embodiments falling within the foregoing description and the appended claims.

What is claimed is:

1. A chuck comprising:
a first housing having a jaw cavity;
a plurality of jaws received in the jaw cavity;
a shaft coupled to the jaws such that relative rotation between the shaft and the first housing translates the jaws so that they converge toward or diverge from a rotational axis of the shaft;
a second housing that is adapted to be non-rotatably coupled to a tool housing of a drill/driver, the second housing including a chuck cavity and an opening, the first housing being received in the chuck cavity, the opening extending through the second housing and intersecting the chuck cavity; and
means coupled to at least one of the first housing and the second housing for inhibiting infiltration of debris through the opening into the chuck cavity.

2. The chuck of claim 1, wherein the debris infiltration inhibiting means includes a seal member that sealingly engages the first and second housings.

3. The chuck of claim 2, wherein the seal member is a lip-type seal having a first portion, which is fixedly coupled to one of the first and second housings, and a second portion that engages a circumferentially extending surface of the other one of the first and second housings.

4. The chuck of claim 2, wherein the seal member is disposed between an interior face of the second housing and a corresponding surface formed on the first housing.

5. The chuck of claim 2, further comprising a shroud member coupled to an outer surface of the second housing, the shroud member closing at least a portion of the opening.

6. The chuck of claim 1, wherein the debris infiltration inhibiting means is configured to produce a flow of air that is forced out the opening.

7. The chuck of claim 6, wherein fan blades are coupled to the first housing.

8. The chuck of claim 7, wherein inlet apertures are formed in the second housing and wherein rotation of the fan blades draws air through the inlet apertures.

9. The chuck of claim 1, wherein the debris infiltration inhibiting means includes a shroud member that is coupled to an outer surface of the second housing, the shroud member closing at least a portion of the opening.

10. A chuck comprising:
a first housing having a jaw cavity;
a plurality of jaws received in the jaw cavity;
a shaft coupled to the jaws such that relative rotation between the shaft and the first housing translates the jaws so that they converge toward or diverge from a rotational axis of the shaft; and
a second housing having a first housing portion and a second housing portion, the first housing portion being adapted to be coupled to a tool housing of a drill/driver, the second housing portion being removably coupled to the first housing portion.

11. The chuck of claim 10, wherein the first and second housing portions are threadably coupled to one another.

12. The chuck of claim 10, wherein one of the first and second housing portions includes a plurality of resilient tabs that are releasably engaged to the other one of the first and second housing portions.

13. The chuck of claim 10, wherein one of the first and second housing portions includes a plurality of bayonet locking elements that are releasably engaged to the other one of the first and second housing portions.

14. The chuck of claim 13, wherein the bayonet locking elements are received through locking apertures in the other one of the first and second housing portions.

15. The chuck of claim 13, wherein the bayonet locking elements are generally L-shaped.

16. The chuck of claim 15, wherein the locking apertures comprise circumferentially extending slots.
